(19) United States
(12) Patent Application Publication
(10) Pub. No.: US 2019/0332227 A1
(43) Pub. Date: Oct. 31, 2019

(54) METHOD AND SYSTEM TO RENDER A DISPLAY FOR A LEGACY COCKPIT SYSTEM USING DATA FROM AN ADVANCED FLIGHT MANAGEMENT SYSTEM

(71) Applicant: HONEYWELL INTERNATIONAL INC., Morris Plains, NJ (US)

(72) Inventors: Mahesh Sivaratri, Bangalore (IN); Sushma Bidrupane, Bangalore (IN); Pranav Patel, Bangalore (IN); Shilpa Melgiri, Bangalore (IN); Phillip Toews, Phoenix, AZ (US); Mythili Belle, Bangalore (IN); Raghu Shamasundar, Bangalore (IN)

(73) Assignee: HONEYWELL INTERNATIONAL INC., Morris Plains, NJ (US)

(21) Appl. No.: 16/220,999

(22) Filed: Dec. 14, 2018

(30) Foreign Application Priority Data
Apr. 30, 2018 (IN) 201841016305

(51) Int. Cl. G06F 3/0481; G09G 5/36; G06F 3/14

(52) U.S. Cl. CPC G06F 3/0481; G09G 5/363; G09G 2320/02; G09G 2380/12; G06F 3/1415

(57) ABSTRACT

Methods and apparatus are provided for rendering a display page for a legacy display unit of an aircraft utilizing data from an advanced Flight Management System (FMS). The method comprises accessing aircraft flight data from a display page generated by the advanced FMS. A mapping table is created by comparing the advanced display page with a display page generated by the legacy display unit. The aircraft data is arranged for a legacy display page layout according to the mapping table. The legacy display page layout is then transmitted to the legacy display unit.

### CROSS-REFERENCE TO RELATED APPLICATION(S)

This application claims priority from India Provisional Patent Application No. 201841016305, titled “Method and System to Render a Display for a Legacy Cockpit System Using Data from an Advanced Flight Management System” that was filed Apr. 30, 2018.

### TECHNICAL FIELD

The present invention generally relates to aircraft operations, and more particularly relates to rendering a display for a legacy cockpit system using data from an advanced flight management system.

### BACKGROUND

A Flight Management System (FMS) is a specialized computer that automates a variety of in-flight tasks such as in-flight management of the flight plan. A world class FMS with the most advanced features delivers safe and cost-efficient flight management to airlines and their aircraft. It is desirable to offer the advanced features of such an FMS in an aircraft cockpit that is equipped with a legacy display system that has been retained as the primary FMS interface. However, providing these capabilities to legacy FMS baseline system may require a significant development cost. Hence, there is a need for a system and method for rendering a display for a legacy cockpit system using data from an advanced FMS.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A method is provided for rendering a display page for a legacy display unit of an aircraft utilizing data from an advanced Flight Management System (FMS). The method comprises: accessing aircraft flight data from a display page generated by the advanced FMS; accessing a mapping table by comparing the advanced display page with a display page generated by the legacy display unit; arranging the aircraft data for a legacy display page layout according to the mapping table; and transmitting the legacy display page layout to the legacy display unit.

A system is provided for rendering a display page for a legacy display unit of an aircraft. The system comprises: an advanced Flight Management System (FMS) that accesses aircraft flight data and generates datasets corresponding to the aircraft flight data; a page data builder that receives the datasets from the advanced FMS and arranges the datasets according to an advanced data protocol for the advanced FMS; a protocol translator that receives the arranged datasets from the page data builder and translates the arranged datasets according to a legacy data protocol; and a legacy display unit that receives the translated datasets and displays the translated datasets on the legacy display unit according to the legacy data protocol.

Furthermore, other desirable features and characteristics of the method and apparatus will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 shows a block diagram of a system of a data communications system for an aircraft in accordance with one embodiment.

FIG. 2 is a block diagram of a computing device in accordance with one embodiment.

FIG. 3 is a detailed block diagram of a computer device onboard an aircraft in accordance with one embodiment.

FIG. 4 shows a block diagram of a Flight Management System (FMS) that renders a display for a multifunction display (MFD) in accordance with one embodiment;

FIG. 5A shows a depiction of a MFD in accordance with one embodiment;

FIG. 5B shows a depiction of a multifunction control and display unit (MCDU) in accordance with one embodiment;

FIG. 6 shows a block diagram of mapping tables generated in accordance with one embodiment;

FIG. 7A shows a block diagram of a system on board an aircraft for rendering MCDU pages in accordance with one embodiment;

FIG. 7B shows a block diagram of a system for rendering MCDU pages in accordance with one embodiment;

FIG. 8 shows a block diagram of rendering an MCDU page using data from an MFD in accordance with one embodiment;

FIG. 9 shows a block diagram of translating an MCDU event for a FMS in accordance with one embodiment; and

FIG. 10 shows a flowchart of a method for rendering an MCDU page using data from an MFD in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

A system and method for rendering a display for a legacy cockpit system using data from an advanced FMS has been developed. Page layouts between more advanced and modern multifunction displays (MFD) and an older legacy multifunction control and display unit (MCDU) have the same general purpose and have similar data displays. Present embodiments use the raw data generated by an advanced Flight Management System (FMS) software package and translate it to build an appropriate MCDU display page. Using the commonality of the data between the similar pages allows the reuse of raw data that is generated by an advanced FMS baseline software package. The solution requires a retrofit of all legacy MCDU equipped systems to enable the core FMS baseline data to be used in order to reduce maintenance costs upgrade costs while providing legacy equipped aircraft with the most advanced FMS performance for their display systems.

As used herein, charts may be any aviation chart or aeronautical chart provided as an informational aid to a flight crew for flight planning purposes. Chart data is any data provided by an electronic chart or a data driven chart (DDC). Aircraft generally use electronic charts for providing a flight crew member with information specific to a particular route and/or airport. Electronic charts may include airport maps; intersections and taxiways data; procedures and data associated with approach, arrival, and departure; and any flight constraints associated with a current flight plan. A flight plan is a proposed strategy for an intended flight, includes details associated with the intended flight, and is usually filed with an air traffic controller (ATC). An intended flight may also be referred to as a “trip” and extends from a departure airport at the beginning point of the trip to a destination airport at the endpoint of the trip. An alert may be any signal or warning indicating potential non-compliance with constraints associated with the current flight plan. The alert may be implemented as a display of text and/or graphical elements, a sound, a light, or other visual or auditory warning signal onboard the aircraft.

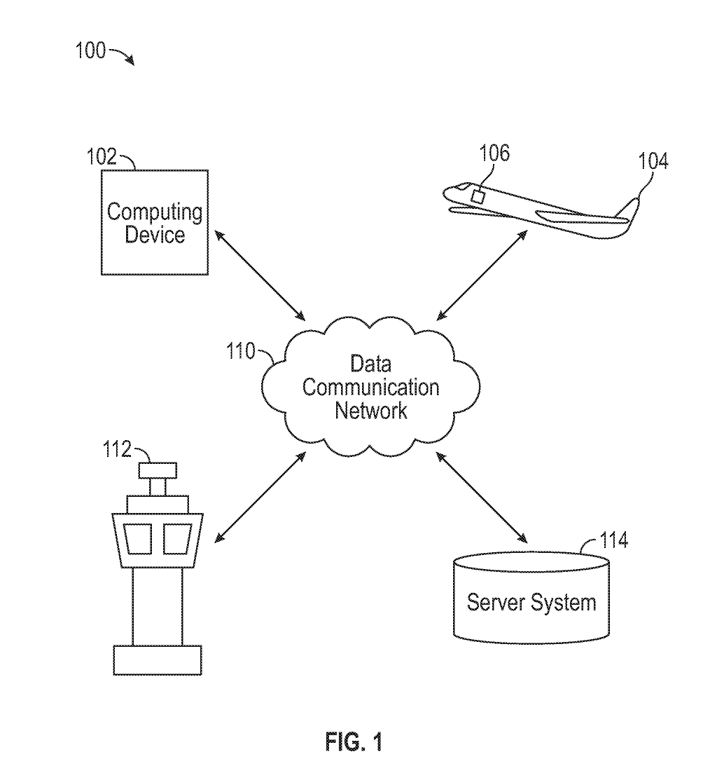

Turning now to the figures, FIG. 1 is a diagram of a system 100 for providing usage of a legacy FMS, in accordance with the disclosed embodiments. The system 100 operates with a current flight of the aircraft 104, to continuously monitor flight data and parameters during flight. The system 100 may include, without limitation, a computing device 102 that communicates with one or more avionics systems 106 onboard the aircraft 104, at least one server system 114, and air traffic control (ATC) 112, via a data communication network 110. In practice, certain embodiments of the system 100 may include additional or alternative elements and components, as desired for the particular application.

The computing device 102 may be implemented by any computing device that includes at least one processor, some form of memory hardware, a user interface, and communication hardware. For example, the computing device 102 may be implemented using a personal computing device, such as a tablet computer, a laptop computer, a personal digital assistant (PDA), a smartphone, or the like. In this scenario, the computing device 102 is capable of storing, maintaining, and executing an Electronic Flight Bag (EFB) application configured to determine and present emergency alerts when flight constraints may not be satisfied by the current flight of the aircraft 104. In other embodiments, the computing device 102 may be implemented using a computer system onboard the aircraft 104, which is configured to determine and present such emergency alerts.

The aircraft 104 may be any aviation vehicle for which flight constraints and alerts associated with non-compliance with flight constraints are relevant and applicable during completion of a flight route. The aircraft 104 may be implemented as an airplane, helicopter, spacecraft, hovercraft, or the like. The one or more avionics systems 106 may include a Flight Management System (FMS), crew alerting system (CAS) devices, automatic terminal information system (ATIS) devices, Automatic Dependent Surveillance-Broadcast (ADS-B), Controller Pilot Data Link Communication (CPDLC), navigation devices, weather radar, aircraft traffic data, and the like. Data obtained from the one or more avionics systems 106 may include, without limitation: an approved flight plan, an estimated time of arrival, instructions from air traffic control (ATC), Automatic Terminal Information Service (ATIS) data, flight plan restriction data, onboard equipment failure data, aircraft traffic data, weather data, or the like.

The server system 114 may include any number of application servers, and each server may be implemented using any suitable computer. In some embodiments, the server system 114 includes one or more dedicated computers. In some embodiments, the server system 114 includes one or more computers carrying out other functionality in addition to server operations. The server system 114 may store and provide any type of data used to determine compliance and/or non-compliance with constraints associated with the current flight. Such data may include, without limitation: flight plan data, flight plan constraint data, and other data compatible with the computing device 102.

The computing device 102 is usually located onboard the aircraft 104, and the computing device 102 communicates with the server system 114 and air traffic control 112 via a wireless communication connection. The computing device 102 and the server system 114 are generally disparately located, and the computing device 102 and air traffic control 112 are generally disparately located. The computing device 102 communicates with the server system 114 and air traffic control 112 via the data communication network 110 and/or via communication mechanisms onboard the aircraft 104.

The data communication network 110 may be any digital or other communications network capable of transmitting messages or data between devices, systems, or components. In certain embodiments, the data communication network 110 includes a packet switched network that facilitates packet-based data communication, addressing, and data routing. The packet switched network could be, for example, a wide area network, the Internet, or the like. In various embodiments, the data communication network 110 includes any number of public or private data connections, links or network connections supporting any number of communications protocols. The data communication network 110 may include the Internet, for example, or any other network based upon TCP/IP or other conventional protocols. In various embodiments, the data communication network 110 could also incorporate a wireless and/or wired telephone network, such as a cellular communications network for communicating with mobile phones, personal digital assistants, and/or the like. The data communication network 110 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

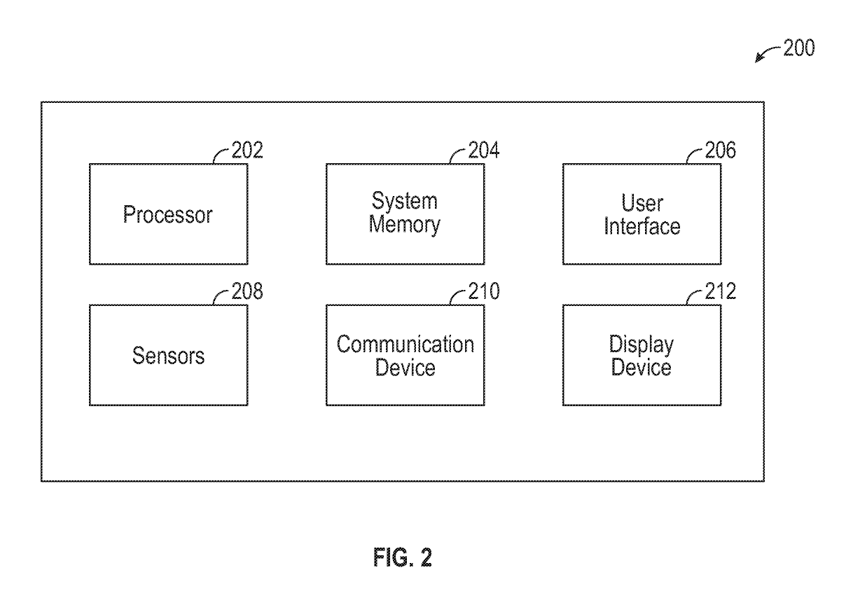

FIG. 2 is a functional block diagram of a computing device 200, in accordance with the disclosed embodiments. It should be noted that the computing device 200 can be implemented with the computing device 102 depicted in FIG. 1. In this regard, the computing device 200 shows certain elements and components of the computing device 102 in more detail.

The computing device 200 generally includes, without limitation: at least one processor 202; system memory 204; a user interface 206; a plurality of sensors 208; a communication device 210; and a display device 212. These elements and features of the computing device 200 may be operatively associated with one another, coupled to one another, or otherwise configured to cooperate with one another as needed to support the desired functionality. For ease of illustration and clarity, the various physical, electrical, and logical couplings and interconnections for these elements and features are not depicted in FIG. 2. Moreover, it should be appreciated that embodiments of the computing device 200 will include other elements, modules, and features that cooperate to support the desired functionality. For simplicity, FIG. 2 only depicts certain elements that are described in more detail below.

The processor 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the processor 202 may be realized as one or more microprocessors, controllers, microcontrollers, or state machines. Moreover, the processor 202 may be implemented as a combination of computing devices, e.g., a combination of digital signal processors and microprocessors, a plurality of microprocessors, one or more microprocessors in conjunction with a digital signal processor core, or any other such configuration.

The processor 202 is communicatively coupled to the system memory 204. The system memory 204 is configured to store any obtained or generated data associated with generating alerts to redirect user attention from the computing device 200 to a critical or high-priority flight situation. The system memory 204 may be realized using any number of devices, components, or modules, as appropriate to the embodiment. Moreover, the computing device 200 could include system memory 204 integrated therein and/or a system memory 204 operatively coupled thereto, as appropriate to the particular embodiment. In practice, the system memory 204 could be realized as RAM memory, flash memory, EPROM memory, EEPROM memory, registers, a hard disk, a removable disk, or any other form of storage medium known in the art. In certain embodiments, the system memory 204 includes a hard disk, which may also be used to support functions of the computing device 200. The system memory 204 can be coupled to the processor 202 such that the processor 202 can read information from, and write information to, the system memory 204. In the alternative, the system memory 204 may be integral to the processor 202. As an example, the processor 202 and the system memory 204 may reside in a suitably designed application-specific integrated circuit (ASIC).

The user interface 206 may include or cooperate with various features to allow a user to interact with the computing device 200. Accordingly, the user interface 206 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the computing device 200. For example, the user interface 206 could be manipulated by an operator to provide flight data parameters during the operation of electronic flight bag (EFB) applications, as described herein.

In certain embodiments, the user interface 206 may include or cooperate with various features to allow a user to interact with the computing device 200 via graphical elements rendered on a display element (e.g., the display device 212). Accordingly, the user interface 206 may initiate the creation, maintenance, and presentation of a graphical user interface (GUI). In certain embodiments, the display device 212 implements touch-sensitive technology for purposes of interacting with the GUI. Thus, a user can manipulate the GUI by moving a cursor symbol rendered on the display device 212, or by physically interacting with the display device 212 itself for recognition and interpretation, via the user interface 206.

The plurality of sensors 208 is configured to obtain data associated with active use of the computing device 200, and may include, without limitation: touchscreen sensors, accelerometers, gyroscopes, or the like. Some embodiments of the computing device 200 may include one particular type of sensor, and some embodiments may include a combination of different types of sensors. Generally, the plurality of sensors 208 provides data indicating whether the computing device 200 is currently being used. Touchscreen sensors may provide output affirming that the user is currently making physical contact with the touchscreen (e.g., a user interface 206 and/or display device 212 of the computing device 200), indicating active use of the computing device. Accelerometers and/or gyroscopes may provide output affirming that the computing device 200 is in motion, indicating active use of the computing device 200.

The communication device 210 is suitably configured to communicate data between the computing device 200 and one or more remote servers and one or more avionics systems onboard an aircraft. The communication device 210 may transmit and receive communications over a wireless local area network (WLAN), the Internet, a satellite uplink/downlink, a cellular network, a broadband network, a wide area network, or the like. As described in more detail below, data received by the communication device 210 may include, without limitation: avionics systems data and aircraft parameters (e.g., a heading for the aircraft, aircraft speed, altitude, aircraft position, ascent rate, descent rate, a current flight plan, a position of air spaces around a current flight plan, and activity of the air spaces around a current flight plan), and other data compatible with the computing device 200. Data provided by the communication device 210 may include, without limitation, requests for avionics systems data, alerts and associated detail for display via an aircraft onboard display, and the like.

The display device 212 is configured to display various icons, text, and/or graphical elements associated with alerts related to situations requiring user attention, wherein the situations are associated with a device or system that is separate and distinct from the computing device 200. In an exemplary embodiment, the display device 212 and the user interface 206 are communicatively coupled to the at least one processor 202. The processor 202, the user interface 206, and the display device 212 are cooperatively configured to display, render, or otherwise convey one or more graphical representations or images associated with high-priority or critical flight situation alerts on the display device 212, as described in greater detail below. In an exemplary embodiment, the display device 212 is realized as an electronic display configured to graphically display critical flight situation alerts and associated detail, as described herein. In some embodiments, the computing device 200 is an integrated computer system onboard an aircraft, and the display device 212 is located within a cockpit of the aircraft and is thus implemented as an aircraft display. In other embodiments, the display device 212 is implemented as a display screen of a standalone, personal computing device (e.g., laptop computer, tablet computer). It will be appreciated that although the display device 212 may be implemented using a single display, certain embodiments may use additional displays (i.e., a plurality of displays) to accomplish the functionality of the display device 212 described herein.

An FMS is a specialized computer that automates a variety of in-flight tasks such as in-flight management of the flight plan. Using various sensors such as global positioning system (GPS), the FMS determines the aircraft's position and guides the aircraft along its flight plan using its navigation database. From the cockpit, the FMS is normally controlled through a visual display device such as a control display unit (CDU) which incorporates a small screen, a keyboard or a touchscreen. The FMS displays the flight plan and other critical flight data to the aircrew during operation.

The FMS may have a built-in electronic memory system that contains a navigational database. The navigational database contains elements used for constructing a flight plan. In some embodiments, the navigational database may be separate from the FMS and located onboard the aircraft while in other embodiments the navigational database may be located on the ground and relevant data provided to the FMS via a communications link with a ground station. The navigational database used by the FMS may typically include: waypoints/intersections; airways; radio navigation aids/navigational beacons; airports; runway; standard instrument departure (SID) information; standard terminal arrival (STAR) information; holding patterns; and instrument approach procedures. Additionally, other waypoints may also be manually defined by pilots along the route.

The flight plan is generally determined on the ground before departure by either the pilot or a dispatcher for the owner of the aircraft. It may be manually entered into the FMS or selected from a library of common routes. In other embodiments the flight plan may be loaded via a communications data link from an airline dispatch center. During preflight planning, additional relevant aircraft performance data may be entered including information such as: gross aircraft weight; fuel weight and the center of gravity of the aircraft. The aircrew may use the FMS to modify the plight flight plan before takeoff or even while in flight for variety of reasons. Such changes may be entered via the CDU. Once in flight, the principal task of the FMS is to accurately monitor the aircraft's position. This may use a GPS, a VHF omnidirectional range (VOR) system, or other similar sensor in order to determine and validate the aircraft's exact position. The FMS constantly cross checks among various sensors to determine the aircraft's position with accuracy.

Additionally, the FMS may be used to perform advanced VNAV functions. The purpose of VNAV is to predict and optimize the vertical path of the aircraft. The FMS provides guidance that includes control of the pitch axis and of the throttle of the aircraft. In order to accomplish these task, the FMS has detailed flight and engine model data of the aircraft. Using this information, the FMS may build a predicted vertical descent path for the aircraft. A correct and accurate implementation of VNAV has significant advantages in fuel savings and on-time efficiency.

In exemplary embodiments, an existing flight management computer (FMC) (or flight management system (FMS)) onboard an aircraft is utilized to communicate data between existing onboard avionics systems or line-replaceable units (LRUs) and another module coupled to the FMC, which supports or otherwise performs new flight management functionality that is not performed by the FMC. For example, a multifunction control and display unit (MCDU) may support or otherwise perform new flight management functionality based on data from onboard avionics or LRUs received via the FMC. In this regard, the FMC is configured to receive operational or status data from one or more avionics systems or LRUs onboard the aircraft at corresponding avionics interfaces and convert one or more characteristics of the operational data to support communicating the operational data with the MCDU. For purposes of explanation, the subject matter may primarily be described herein in the context of converting operational data received from onboard avionics or LRUs in a first format (e.g., an avionics bus format) into another format supported by the interface with the MCDU, the subject matter described herein is not necessarily limited to format conversions or digital reformatting, and may be implemented in an equivalent manner for converting between other data characteristics, such as, for example, different data rates, throughputs or bandwidths, different sampling rates, different resolutions, different data compression ratios, and the like.

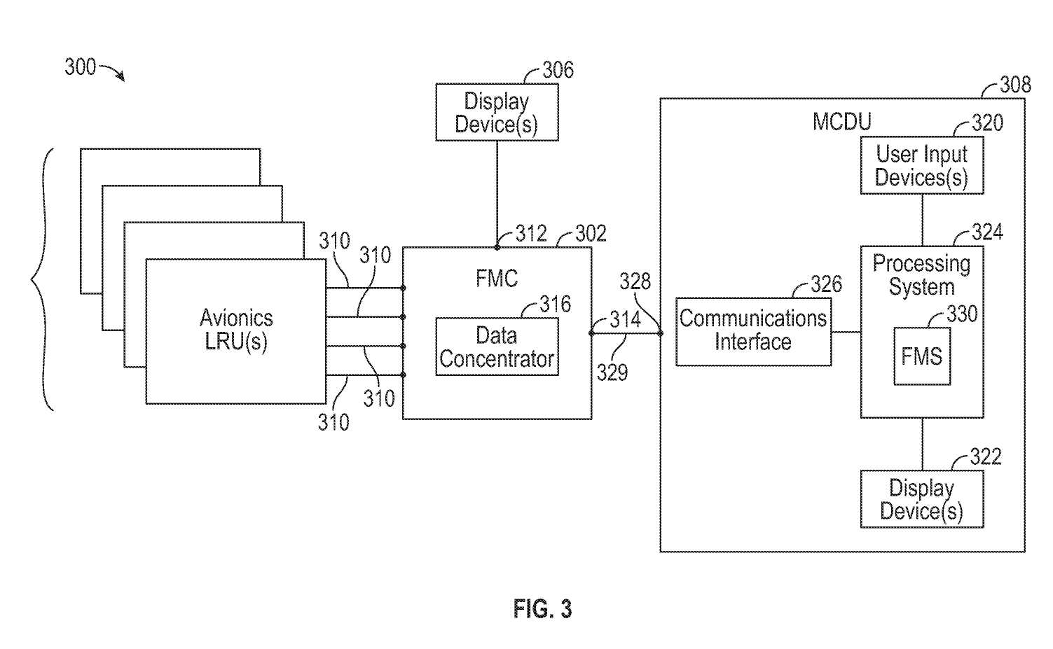

FIG. 3 depicts a detailed block diagram of a computer device onboard 300 an aircraft suitable for implementation onboard an aircraft in accordance with one embodiment. The computer device 300 corresponds with the computing device 102 and 200 shown previously in FIGS. 1 and 2 respectively. The illustrated aircraft system 300 includes a flight management computing module 302 communicatively coupled to a plurality of onboard avionics LRUs 304, one or more display devices 306, and a multifunction computing module 308. It should be appreciated that FIG. 3 depicts a simplified representation of the aircraft system 300 for purposes of explanation, and FIG. 3 is not intended to limit the subject matter in any way.

The flight management computing module 302 generally represents the FMC, the FMS, or other hardware, circuitry, logic, firmware and/or other components installed onboard the aircraft and configured to perform various tasks, functions and/or operations pertaining to flight management, flight planning, flight guidance, flight envelope protection, four-dimensional trajectory generation or required time of arrival (RTA) management, and the like. Accordingly, for purposes of explanation, but without limiting the functionality performed by or supported at the flight management computing module 302, the flight management computing module 302 may alternatively be referred to herein as the FMC. The FMC 302 includes a plurality of interfaces 310 configured to support communications with the avionics LRUs 304 along with one or more display interfaces 312 configured to support coupling one or more display devices 306 to the FMC 302. In the illustrated embodiment, the FMC 302 also includes a communications interface 314 that supports coupling the multifunction computing module 308 to the FMC 302.

The FMC 302 generally includes a processing system designed to perform flight management functions, and potentially other functions pertaining to flight planning, flight guidance, flight envelope protection, and the like. Depending on the embodiment, the processing system could be realized as or otherwise include one or more processors, controllers, application specific integrated circuits, programmable logic devices, discrete gate or transistor logics, discrete hardware components, or any combination thereof. The processing system of the FMC 302 generally includes or otherwise accesses a data storage element (or memory), which may be realized as any sort of non-transitory short or long term storage media capable of storing programming instructions for execution by the processing system of the FMC 302. In exemplary embodiments, the data storage element stores or otherwise maintains code or other computer-executable programming instructions that, when read and executed by the processing system of the FMC 302, cause the FMC 302 to implement, generate, or otherwise support a data concentrator application 316 that performs certain tasks, operations, functions, and processes described herein.

The avionics LRUs 304 generally represent the electronic components or modules installed onboard the aircraft that support navigation, flight planning, and other aircraft control functions in a conventional manner and/or provide real-time data and/or information regarding the operational status of the aircraft to the FMC 302. For example, practical embodiments of the aircraft system 300 will likely include one or more of the following avionics LRUs 304 suitably configured to support operation of the aircraft: a weather system, an air traffic management system, a radar system, a traffic avoidance system, an autopilot system, an autothrottle (or autothrust) system, a flight control system, hydraulics systems, pneumatics systems, environmental systems, electrical systems, engine systems, trim systems, lighting systems, crew alerting systems, electronic checklist systems, and/or another suitable avionics system.

In exemplary embodiments, the avionics interfaces 310 are realized as different ports, terminals, channels, connectors, or the like associated with the FMC 302 that are connected to different avionics LRUs 304 via different wiring, cabling, buses, or the like. In this regard, the interfaces 310 may be configured to support different communications protocols or different data formats corresponding to the respective type of avionics LRU 304 that is connected to a particular interface 310. For example, the FMC 302 may communicate navigation data from a navigation system via a navigation interface 310 coupled to a data bus supporting the ARINC 424 (or A424) standard, the ARINC 629 (or A629) standard, the ARINC 422 (or A422) standard, or the like. As another example, a datalink system or other communications LRU 304 may utilize an ARINC 619 (or A619) compatible avionics bus interface for communicating datalink communications or other communications data with the FMC 302.

The display device(s) 306 generally represent the electronic displays installed onboard the aircraft in the cockpit, and depending on the embodiment, could be realized as one or more monitors, screens, liquid crystal displays (LCDs), a light emitting diode (LED) displays, or any other suitable electronic display(s) capable of graphically displaying data and/or information provided by the FMC 302 via the display interface(s) 312. Similar to the avionics interfaces 310, the display interfaces 312 are realized as different ports, terminals, channels, connectors, or the like associated with the FMC 302 that are connected to different cockpit displays 306 via corresponding wiring, cabling, buses, or the like. In one or more embodiments, the display interfaces 312 are configured to support communications in accordance with the ARINC 661 (or A661) standard. In one embodiment, the FMC 302 communicates with a lateral map display device 306 using the ARINC 702 (or A702) standard.

In exemplary embodiments, the multifunction computing module 308 is realized as a multifunction control and display unit (MCDU) that includes one or more user interfaces, such as one or more input devices 320 and/or one or more display devices 322, a processing system 324, and a communications module 326. The MCDU 308 generally includes at least one user input device 320 that is coupled to the processing system 324 and capable of receiving inputs from a user, such as, for example, a keyboard, a key pad, a mouse, a joystick, a directional pad, a touchscreen, a touch panel, a motion sensor, or any other suitable user input device or combinations thereof. The display device(s) 322 may be realized as any sort of monitor, screen, LCD, LED display, or other suitable electronic display capable of graphically displaying data and/or information under control of the processing system 324.

The processing system 324 generally represents the hardware, circuitry, logic, firmware and/or other components of the MCDU 308 configured to perform the various tasks, operations, functions and/or operations described herein. Depending on the embodiment, the processing system 324 may be implemented or realized with a general purpose processor, a microprocessor, a controller, a microcontroller, a state machine, an application specific integrated circuit, a field programmable gate array, any suitable programmable logic device, discrete gate or transistor logic, discrete hardware components, or any combination thereof, designed to perform the functions described herein. Furthermore, the steps of a method or algorithm described in connection with the embodiments disclosed herein may be embodied directly in hardware, in firmware, in a software module executed by the processing system 324, or in any practical combination thereof. In this regard, the processing system 324 includes or accesses a data storage element (or memory), which may be realized using any sort of non-transitory short or long term storage media, and which is capable of storing code or other programming instructions for execution by the processing system 324. In exemplary embodiments described herein, the code or other computer-executable programming instructions, when read and executed by the processing system 324, cause the processing system 324 to implement or otherwise generate a flight management system application 330 and perform additional tasks, operations, functions, and processes described herein.

The communications module 326 generally represents the hardware, module, circuitry, software, firmware and/or combination thereof that is coupled between the processing system 324 and a communications interface 328 of the MCDU 308 and configured to support communications between the MCDU 308 and the FMC 302 via an electrical connection 329 between the MCDU communications interface 328 and the FMC communications interface 314. For example, in one embodiment, the communications module 326 is realized as an Ethernet card or adapter configured to support communications between the FMC 302 and the MCDU 308 via an Ethernet cable 329 provided between Ethernet ports 314, 328. In other embodiments, the communications module 326 is configured to support communications between the FMC 302 and the MCDU 308 in accordance with the ARINC 429 (A429) standard via an A429 data bus 329 provided between A429 ports 314, 328 of the respective modules 302, 308. In yet other embodiments, the communications module 326 is configured to support communications between the FMC 302 and the MCDU 308 in accordance with the ARINC 422 (A422) standard via an A422 data bus 329 provided between A422 ports 314, 328 of the respective modules 302, 308. In yet other embodiments, the communications module 326 is configured to support communications between the FMC 302 and the MCDU 308 in accordance with the ARINC 739 (A739) standard or any other MCDU standard (RS232 as databus for a character-based standard). Communications is established via an A429 data bus 329 provided between A429 ports 314, 328 of the respective modules 302, 308.

In various embodiments, the FMC 302 and MCDU 308 communicate using a different communications protocol or standard than one or more of the avionics LRUs 304 and/or the display devices 306. In such embodiments, to support communications of data between the MCDU 308 and those LRUs 304 and/or display devices 306, the data concentrator application 316 at the FMC 302 converts data from one format to another before retransmitting or relaying that data to its destination. For example, the data concentrator application 316 may convert data received from an avionics LRU 304 to the A429 or Ethernet format before providing the data to the MCDU 308, and vice versa. Additionally, in exemplary embodiments, the FMC 302 validates the data received from an avionics LRU 304 before transmitting the data to the MCDU 308. For example, the FMC 302 may perform debouncing, filtering, and range checking, and/or the like prior to converting and retransmitting data from an avionics LRU 304.

It should be noted that although the subject matter may be described herein in the context of the multifunction computing module 308 being realized as an MCDU, in alternative embodiments, the multifunction computing module 308 could be realized as an electronic flight bag (EFB) or other mobile or portable electronic device. In such embodiments, an EFB capable of supporting a FMS 330 application may be connected to a onboard FMC 302 using an Ethernet cable 329 to support flight management functionality from the EFB in an equivalent manner as described herein in the context of the MCDU.

In one or more embodiments, the MCDU 308 stores or otherwise maintains programming instructions, code, or other data for programming the FMC 302 and transmits or otherwise provides the programming instructions to the FMC 302 to update or otherwise modify the FMC 302 to implement the data concentrator application 316. For example, in some embodiments, upon establishment of the connection 329 between modules 302, 308, the MCDU 308 may automatically interact with the FMC 302 and transmit or otherwise provide the programming instructions to the FMC 302, which, in turn, executes the instructions to implement the data concentrator application 316. In some embodiments, the data concentrator application 316 may be implemented in lieu of flight management functionality by the MCDU 308 reprogramming the FMC 302. In other embodiments, the FMC 302 may support the data concentrator application 316 in parallel with flight management functions. In this regard, the FMC 302 may perform flight management functions, while the FMS 330 application on the MCDU 308 supplements the flight management functions to provide upgraded flight management functionality within the aircraft system 300.

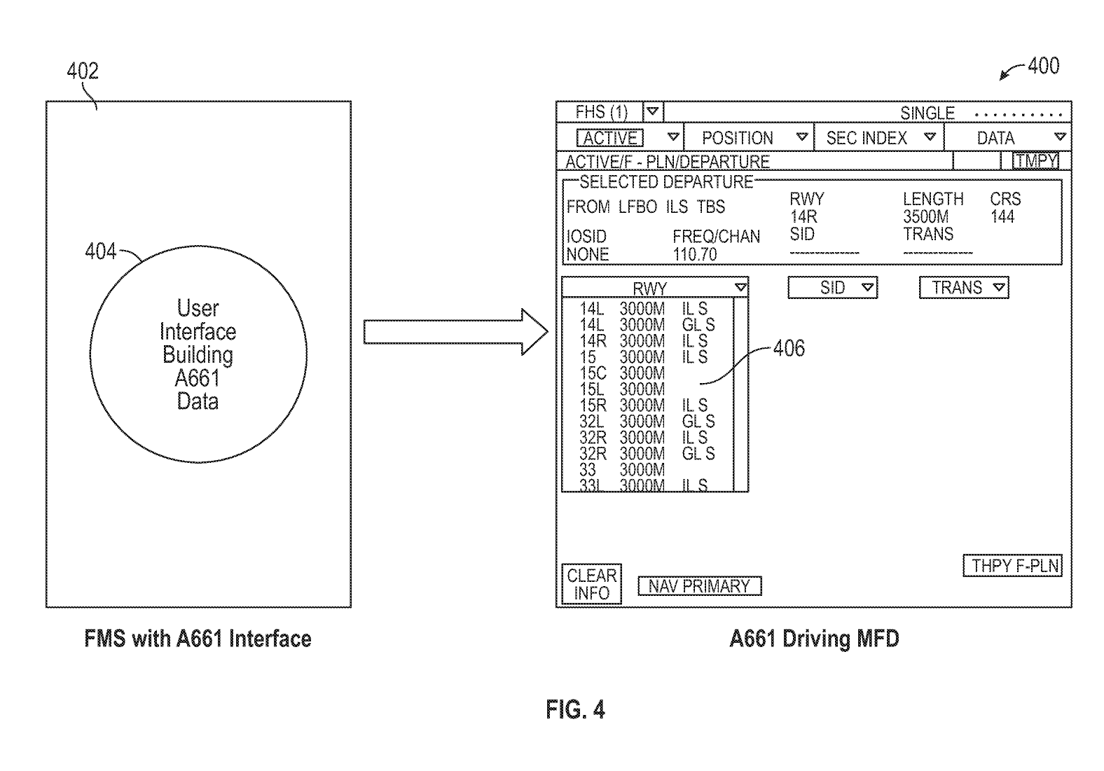

FIG. 4 shows a block diagram 400 of an advanced FMS 402 that renders a display for an MFD 406 in accordance with one embodiment. The advanced FMS 402 corresponds to the FMS 330 shown previously in FIG. 3. In some embodiments, the advanced FMS 402 uses a user interface 404 to build a page layout that is displayed on the MFD 406 using the A661 protocol. The A661 protocol is an industry standard for cockpit display systems (CDS) as established by the Airline Electronic Engineering Committee (AEEC). The A661 protocol (i.e., “advanced data protocol”) is generally used by advanced FMS software to format data for advanced page layouts for an MFD. In contrast, an older legacy MCDU uses the A739 data protocol (i.e., “legacy data protocol”) which is the industry standard for MCDU layout pages.

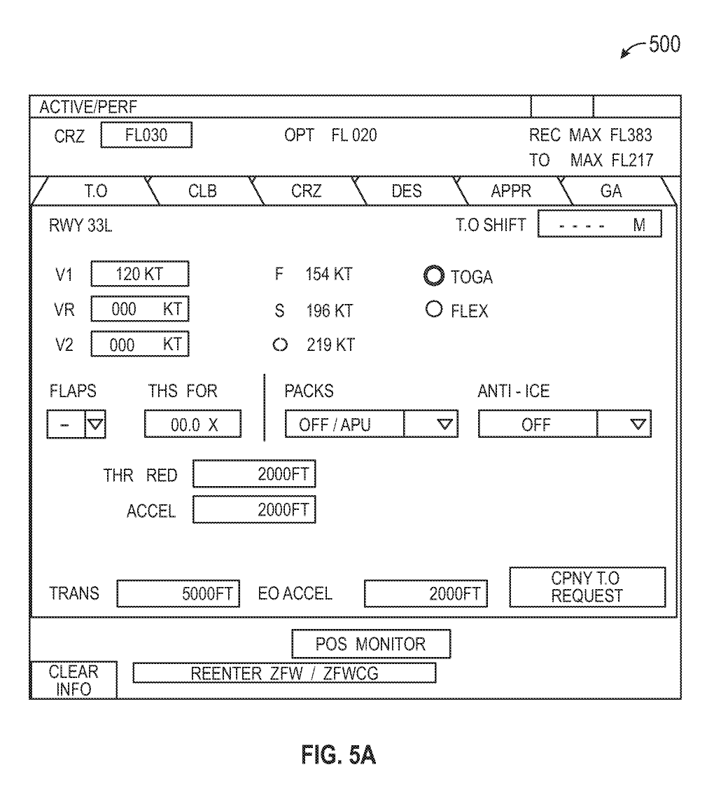

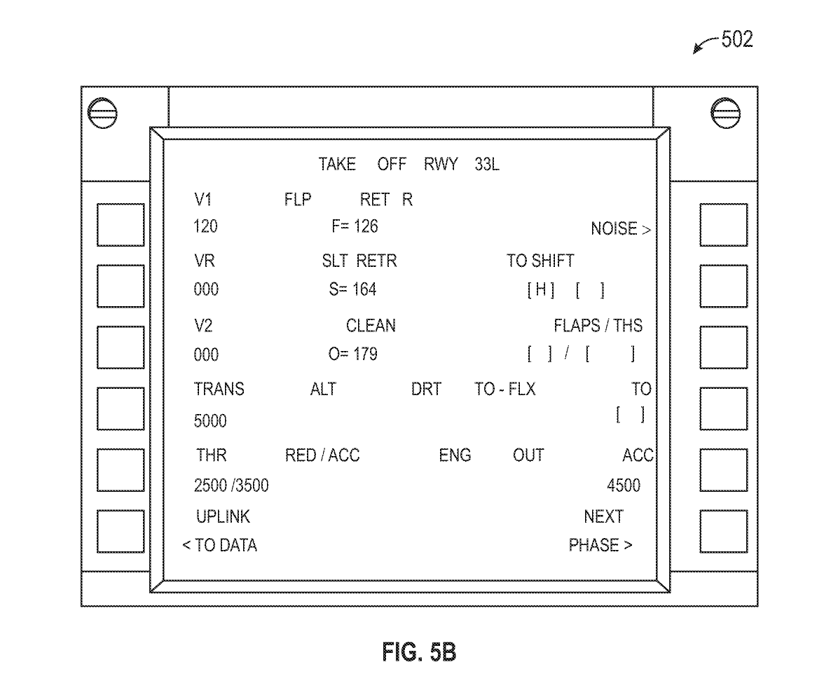

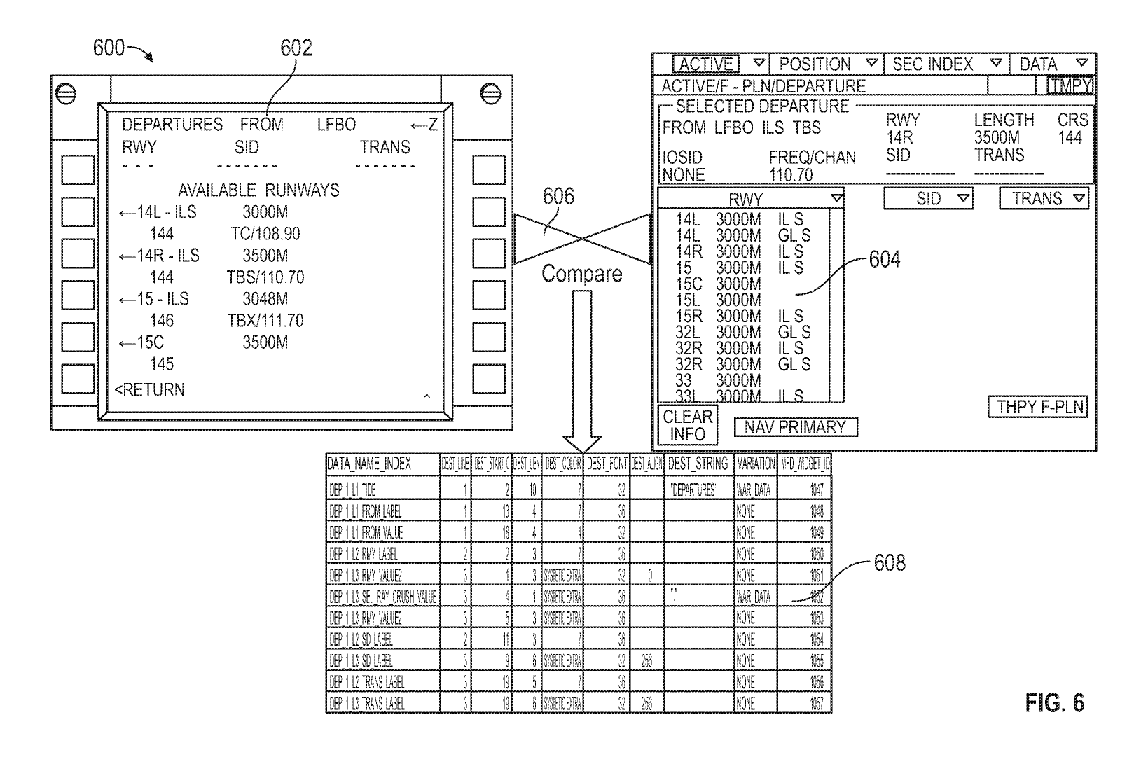

FIG. 5A shows a depiction of an MFD display 500 in accordance with one embodiment while FIG. 5B shows a depiction of an MCDU display 502. The MFD display 406 corresponds to a display for the MFD 406 shown previously in FIG. 4. As can be seen, both pages are designed for similar purpose and have mostly similar data displayed. However, some data may be omitted or included from one display unit or the other. Regardless, each display 500 and 502 has the data displayed in different locations, formats, units, etc. In order to efficiently translate between the A661 and A739 protocols, a page data mapping table is created. FIG. 6 shows a block diagram 600 of page data mapping tables 608 generated in accordance with one embodiment. The mapping table 608 is created by comparing 606 the displays of the MCDU 602 and MFD 604 to capture the similarities and differences between the displayed data. The MFD display 604 corresponds to the MFD display 500 shown previously in FIG. 5a. The MCDU display 602 corresponds to the MCDU display 502 shown previously in FIG. 5b. Once the table 608 is created, standard data mining techniques are used to extract the details and build a display page layout for the MCDU. Conversely, the table 608 may be used to compare and translate user inputs from the MCDU 602 and its legacy data protocol into the advanced data protocol for the MFD. These translated user inputs may be sent back to the advanced FMS for storage, processing, reference, etc.

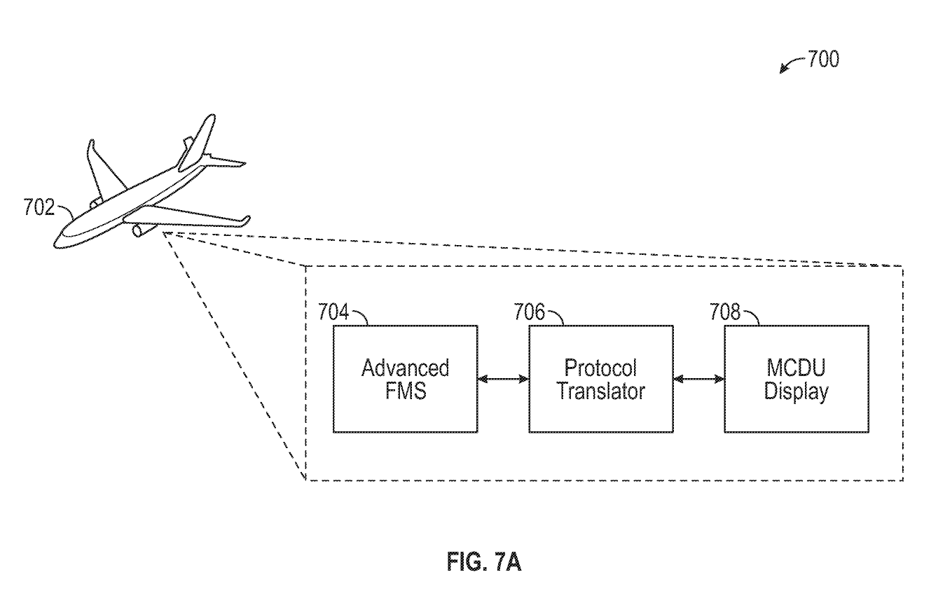

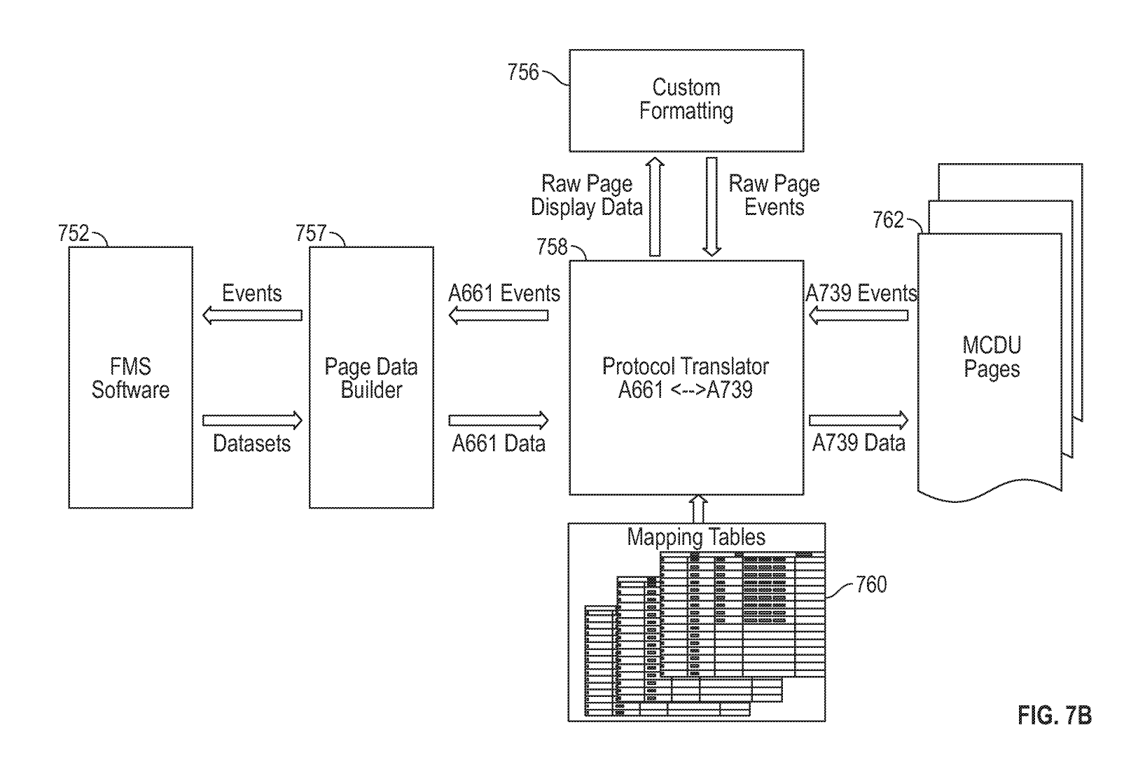

FIG. 7a shows a block diagram 700 of a system on board an aircraft 702 for rendering MCDU pages in accordance with one embodiment. The system includes an advanced FMS 704 that is in communication with an MCDU display unit 708 in use by the aircrew. The advanced FMS 704 corresponds to the advanced FMS 402 shown previously in FIG. 4. The MCDU display 708 corresponds to the MCDU display 602 shown previously in FIG. 6. The advanced FMS 704 communicates with the MCDU display unit 708 via a Protocol Translator 706. FIG. 7b shows a block diagram 750 of a system for rendering MCDU pages 762 in accordance with one embodiment. In this embodiment, the FMS software 752 generates datasets that are transmitted to the page data builder 757. The page data builder 757 arranges the data in the A661 protocol and transmits it to a protocol translator 758. The protocol translator 758 corresponds to the protocol translator 706 shown previously in FIG. 7a. The protocol translator 758 consults the mapping tables 760 as well as any custom formatting requirements 756 and creates a display page layout in compliance with the A739 protocol. The mapping tables 760 correspond to the mapping tables 608 shown previously in FIG. 6. The A739 compliant page layout is then transmitted to the MCDU 762 for display to the aircrew. In some embodiments, the custom formatting requirements are selected and stored in the advanced FMS.

Any user created “events” through a user interface with the MCDU 762 are transmitted to the protocol translator 758 in the A739 protocol format. As with the display rendering, the protocol translator 758 consults the mapping tables 760 along with any custom formatting requirements 756 and translates the A739 compliant events into the A661 advanced data protocol. The A661 events are transmitted to the page data builder 757 and then passed along to the FMS 752 for processing.

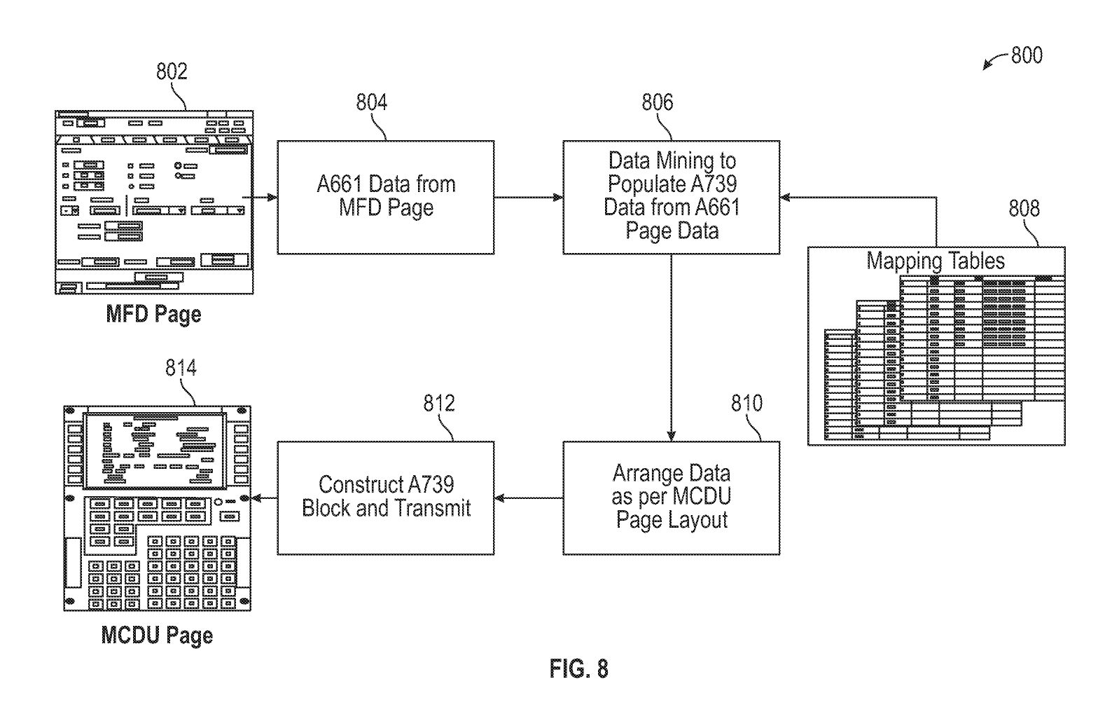

FIG. 8 shows a detail block diagram 800 of rendering an MCDU page 814 using data from an MFD 802 in accordance with one embodiment. The MCDU page 814 corresponds to the MCDU page 502 shown previously in FIG. 5b. The MFD 802 corresponds to the MFD 500 shown previously in FIG. 5a. In this example, data in the A661 format 804 is extracted from the MFD page 802. The data is mined 806 to populate A739 data fields according to the mapping tables 808. The mapping tables 808 correspond to the mapping tables 760 shown previously in FIG. 7b. The data is arranged according to the MCDU page layout requirements 810 and A739 compliant block display 812 is created and transmitted to the MCDU 814.

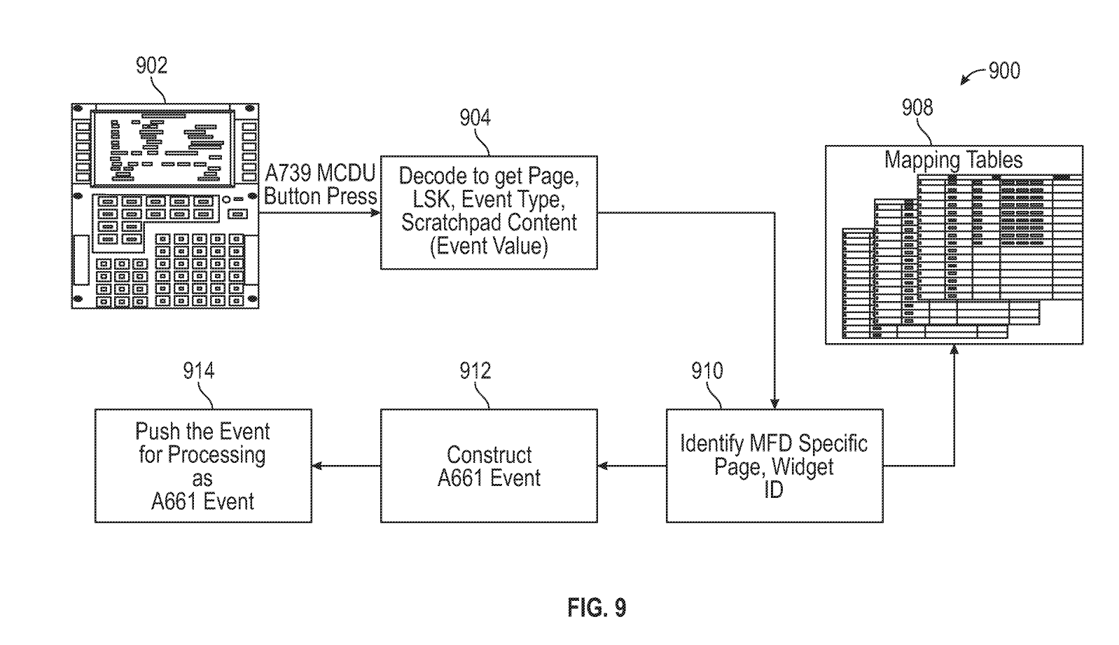

FIG. 9 shows a detail block diagram 900 of translating and MCDU 902 event for a FMS in accordance with one embodiment. In this example, user input creates an event for the MCDU 902 in A739 format. The MCDU 902 corresponds to the MCDU display unit 708 shown previously in FIG. 7a. The event is decoded 904 to obtain the page, line select key (LSK), event type, content, etc. The decoded event is identified 910 by the specific “widget” for the MFD by consulting mapping tables 908. The mapping tables 908 correspond to the mapping tables 760 shown previously in FIG. 7b. A widget is an element of a graphical user interface (GUI) that provides a specific way for a user to interact with the application. A widget may include icons, pulldown menus, buttons, selection boxes, scrollbars, toggle buttons and other similar devices for inviting, accepting and responding to user actions. This information is used to construct 912 an A661 formatted event that is pushed 914 to the FMS for processing.

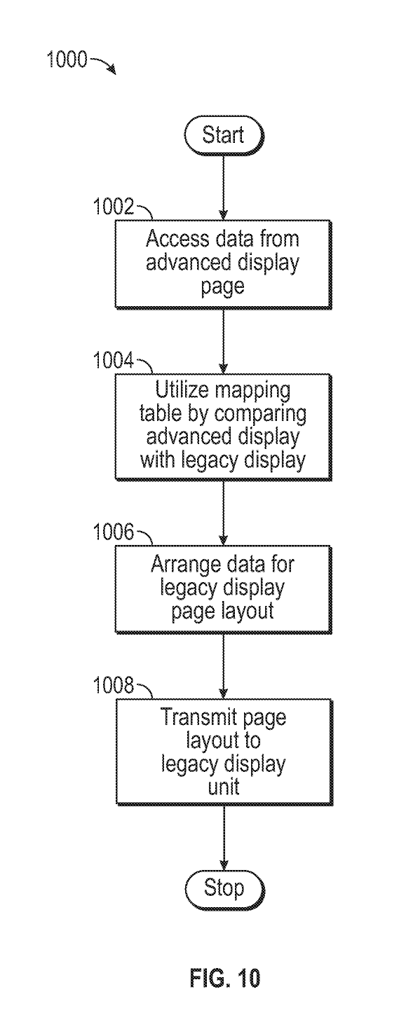

FIG. 10 shows a flowchart 1000 of a method for rendering and MCDU page using data from an MFD in accordance with one embodiment. In this embodiment, data is accessed 1002 from the advanced display page that is generated by the FMS software from an advanced FMS. A mapping table is utilized 1004 by comparing the advanced display with the legacy display. The data from the advanced display is arranged 1006 for a legacy display page layout by a protocol translator according to the mapping table. The legacy display is arranged according to the legacy display data protocol. Once the legacy display is formatted, it is transmitted 1008 to the legacy display unit for display to the aircrew.

In some embodiments, only the FMS software will be updated with no changes required in a hardware at the user interface level. Any change to the hardware will potentially be costly and time-consuming with regards to regulatory certification. As a result, present embodiments have advantages that include: reuse of advanced FMS software for all baselines irrespective of the difference in display units; providing aircraft with highly advanced FMS with little/no change in hardware; using a single the FMS baseline for all aircraft to reduce the maintenance cost; and simplifying certification of upgrades of FMS software.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for rendering a display page for a legacy display unit of an aircraft utilizing data from an advanced Flight Management System (FMS), comprising:
accessing aircraft flight data from a display page generated by the advanced FMS;
utilizing a mapping table by comparing the advanced display page with a display page generated by the legacy display unit;
arranging the aircraft data for a legacy display page layout according to the mapping table; and
transmitting the legacy display page layout to the legacy display unit.

2. The method of claim 1, where the advanced FMS supports a multi-function display (MFD) unit.

3. The method of claim 2, where the MFD unit is A661 standard compliant.

4. The method of claim 1, where the legacy display unit comprises a multi-purpose control and display unit (MDCU).

5. The method of claim 4, where the MDCU is A739 standard compliant.

6. A system for rendering a display page for a legacy display unit of an aircraft, comprising:
an advanced Flight Management System (FMS) that accesses aircraft flight data and generates datasets corresponding to the aircraft flight data;
a page data builder that receives the datasets from the advanced FMS and arranges the datasets according to an advanced data protocol for the advanced FMS;
a protocol translator that receives the arranged datasets from the page data builder and translates the arranged datasets according to a legacy data protocol; and
a legacy display unit that receives the translated datasets and displays the translated datasets on the legacy display unit according to the legacy data protocol.

7. The system of claim 6, where the advanced FMS supports a multi-function display (MFD) unit.

8. The system of claim 6, where the advanced data protocol comprises the A661 data protocol.

9. The system of claim 6, where the legacy display unit comprises a multi-purpose control and display unit (MDCU).

10. The system of claim 6, where the legacy data protocol comprises the A739 data protocol.

11. The system of claim 6, where the protocol translator consults a mapping table to translate the arranged datasets.

12. The system of claim 11, where the mapping table is created by comparing a multi-function display (MFD) unit display page with a display page generated by the legacy display unit.

13. The system of claim 6, where the protocol translator consults custom formatting requirements to translate the arranged datasets.

14. The system of claim 13, where the custom formatting requirements are stored in the advanced FMS.

15. The system of claim 6, where the legacy display unit creates an event based on a user input, where the event is transmitted to the protocol translator in the legacy data protocol.

16. The system of claim 15, where the protocol translator decodes and identifies the event and creates a translated event in the advanced data protocol that is sent to the advanced FMS.

17. The system of claim 16, where the protocol translator references a mapping table to identify the event.
